(19) United States
(12) Patent Application Publication
(10) Pub. No.: US 2012/0245913 A1
(43) Pub. Date: Sep. 27, 2012

(54) SYSTEMS AND METHODS FOR CREATING AND USING OPTIMIZATION RESPONSE SURFACES

(76) Inventor: Thomas B. Neville, Incline Village, NV (US)

(21) Appl. No.: 13/425,651

(22) Filed: Mar. 21, 2012

Related U.S. Application Data
(60) Provisional application No. 61/454,788, filed on Mar. 21, 2011.

(51) Int. Cl. G06G 7/60

(52) U.S. Cl. 703/11

(57) ABSTRACT

A system and a method including: receiving a first set of data associated with a first person; receiving a second set of data associated with a second person; determining a common set of characterization parameters present in the first and second sets of data; determining whether the data satisfies a similarity threshold; and, if the common set of characterization parameters satisfies a similarity threshold, determining a response surface fitted to the first and second sets of data. A system and method including: receiving a set of characterization parameters associated with a patient; querying a database storing response surfaces each corresponding to a patient population with a set of common characterization parameters; receiving an applicable response surface; and providing a treatment option for the patient based on a maximum point of the applicable response surface.

### CROSS-REFERENCE TO RELATED APPLICATIONS

This application claims the benefit of U.S. Provisional Patent Application Ser. No. 61/454,788, entitled “Life optimization system with life optimization response surfaces” and filed 21Mar. 2011, the entirety of which is incorporated herein by this reference.

### TECHNICAL FIELD

This invention relates generally to the medical field, and more specifically to new and useful systems and methods for creating and using optimization response surfaces.

### BACKGROUND

There is a need to create a practical way to optimize life of a person over time, such as in terms of health and overall well-being. For instance, one cannot perform every one of many possible actions to move towards life optimization due to constraints such as time, money, energy, and emotional strength. Furthermore, there are many outcomes that comprise overall well-being, and current measurements of well-being are subjective and imprecise. Even further, dynamic characteristics of well-being, such as changing life circumstances and ageing, often complicate assessment of and optimization of life over time. Thus, there is a need to create new and useful systems and methods that address these issues. This invention provides such new and useful systems and methods for creating and using optimization response surfaces.

### BRIEF DESCRIPTION OF THE FIGURES

FIG. 1 is a schematic of relationships within a life optimization system of a preferred embodiment;

FIGS. 2A-2C are schematics of a system for creating and maintaining a response surface of a preferred embodiment;

FIGS. 3-6 are flowcharts of a method for creating and maintaining a response surface of a preferred embodiment;

FIG. 7 is a schematic of relationships within a life optimization system of an exemplary application in treatment of depression;

FIGS. 8-11 are exemplary response surfaces created by systems and methods of a preferred embodiment;

FIGS. 12A-12C are exemplary schematics of an experimental design to create life score response surfaces using systems and methods of a preferred embodiment, and exemplary life score response surfaces created by the systems and methods of a preferred embodiment, respectively;

FIG. 13 is a schematic of a system for using a response surface of a preferred embodiment;

FIGS. 14A and 14B are flowcharts of a method for using a response surface of a preferred embodiment and variations thereof;

FIG. 15 is an exemplary life score response surface being traversed with a hill climbing algorithm in an exemplary application of preferred embodiments of the systems and methods in treatment of depression; and

FIG. 16 is a schematic of a time series forming a dynamic response surface of a preferred embodiment; and

FIGS. 17 and 18 are exemplary dynamic well-being and biomarker response surfaces, respectively, in exemplary applications of the preferred embodiments of systems and methods.

### DESCRIPTION OF THE PREFERRED EMBODIMENTS

The following description of preferred embodiments of the invention is not intended to limit the invention to these preferred embodiments, but rather to enable any person skilled in the art to make and use this invention.

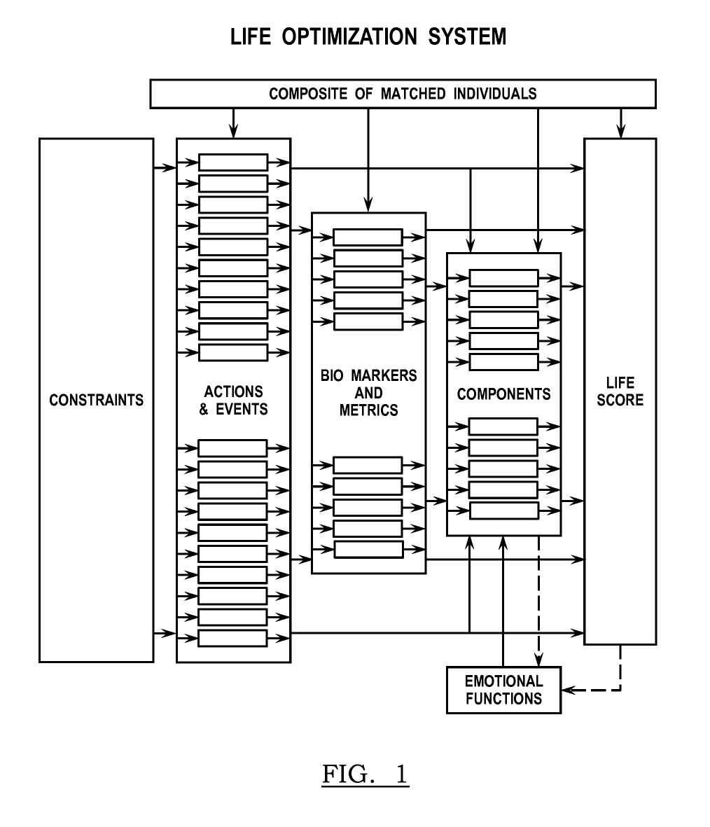

As shown in FIG. 1, life optimization for an individual can be described as a function of interaction between: constraints to actions; actions (under the control of the individual) and events (that affect the individual but are outside the control of the individual) that have life consequences; biomarkers (biologic indicators, such as blood proteins) and other metrics (anything besides biomarkers that can be measured) that allow measurement of one or more characteristic parameters of the individual; life score, which is an overall measure of life well-being dependent on multiple discrete life components (e.g., qualitative descriptors of well-being, probabilistic life expectancy); and emotional functions that adjust the relationship between life score and life components.

Life score preferably includes at least two dimensions or components, including life gauge and lifetime. Life gauge is preferably a broad measure of how an individual feels about his or her life, and can be measured by subjective questionnaires that correlate with other apparent indicators of high life satisfaction and happiness such as smiling, ratings by friends, sleep quality, etc. Lifetime is preferably an estimated probability distribution of expectations that can be estimated by life expectancy models as a function of condition and situation of an individual. For example, life expectancy models can be based on actuarial tables and/or studies of the effect of certain conditions and actions (e.g., diet, exercise, smoking habits).

As shown in FIG. 1, life optimization response surfaces preferably define estimated models for life score (or biomarkers, well-being or other outcomes) as a function of one or more variables of life optimization for particular types of individuals. The response surfaces preferably help an individual optimize his or her life score, health, well-being, or other outcomes. For instance, such response surfaces preferably provide information on how an individual can proactively change his or her actions to achieve an optimum. A response surface can be relatively complex (e.g., multi-dimensional as a function of multiple variables) or can be relatively simple (e.g. as a function of a single variable such as one particular kind of action). A response surface can be static (independent of time) or dynamic (incorporating a temporal dimension, as a time-dependent series of static response surfaces). In other words, there is a dynamic response surface that incorporates the time dimension for every static response surface.

Over his or her lifetime, an individual is subjected to gradual and/or abrupt events or changes (e.g., change in medication, diet, death of a spouse, loss of a job), which can cause substantial shifts in biomarker response surfaces, life score response surface, overall well-being response surface, and/or other kinds of life optimization response surfaces for an individual. Such events and changes can cause substantial shifts in the response surfaces for an individual, and after an event or change, life optimization can take longer because of the time needed to perform enough trial and error experiments to define the new shifted response surface or surfaces particular to that individual. The systems and methods described herein preferably enable anticipatory optimization with synthetic response surfaces that anticipate a probable response surface for an individual after life events and changes. In other words, the synthetic response surfaces can be used to predict a new optimum for an individual, based on the experience of others who are similar to and/or have endured similar life events and changes matching those of the individual, and thereby likely have response surfaces similar to that of the individual. Having a synthetic response surface that is sufficiently similar to the unknown, “real” response surface for an individual allows the individual to take one or more actions immediately to move relatively quickly to a new optimum on the synthetic response surface that is near the actual new optimum on the “real” response surface for that individual, with less trial-and-error experimentation.

Actions by an individual preferably provide feedback to the creation of the response surfaces. For instance, an individual might take a first action based on an appropriately matched synthetic response surface, and the action causes changes in at least one of: biomarkers and metrics, components of life score (life gauge of well-being and lifetime), and life score. Any of these changes can be considered new data, which can be analyzed and incorporated into a new, updated response surface. The new response surface can then guide the choice of the next action or actions in pursuit of life optimization.

For clarity, the systems and methods are primarily described herein as for creating and using synthetic biomarker response surfaces that model biomarker levels (e.g., blood proteins, hormones) as a function of actions. However, similar systems and methods apply to other suitable response surfaces, such as well-being metric response surfaces or life score response surfaces.

### System for Creating and Maintaining a Response Surface

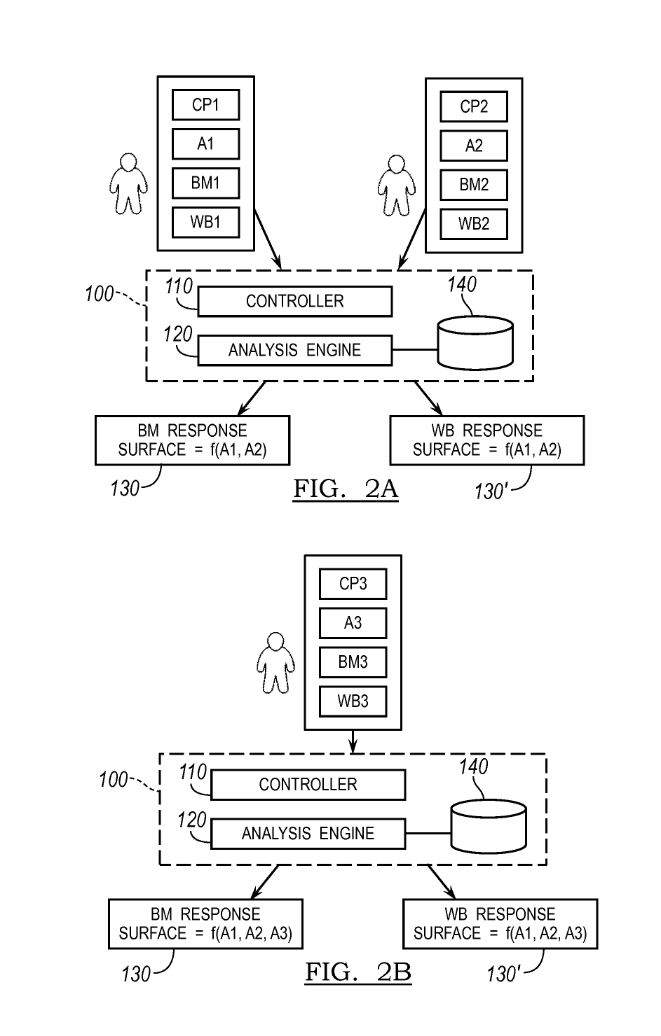

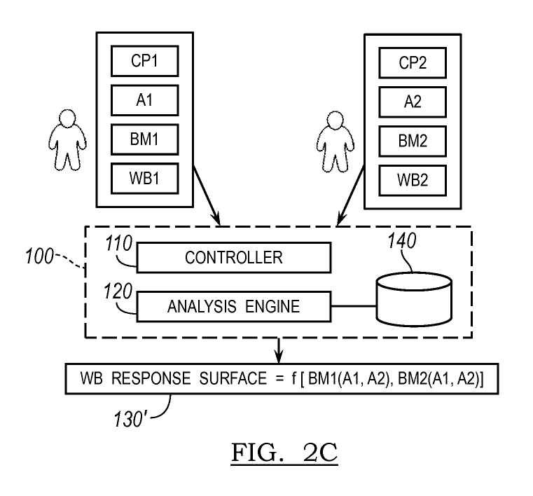

As shown in FIGS. 2A and 2B, a preferred system 100 for creating and maintaining a synthetic response surface includes: a controller 110 configured to receive sets of characterization parameters, sets of actions, and sets of biomarker outcomes each associated with various persons; and an analysis engine 120 coupled to the controller 110 and configured to determine a common set of characterization parameters and a biomarker response surface 130 fitted to the sets of biomarker outcomes as a function of the first and second sets of actions. The biomarker response surface 130 preferably is associated with a particular group (type) of persons sharing the common set of characterization parameters.

As shown in FIG. 2A, the controller 110 preferably functions to receive sets of data, including characterization parameters, actions, and biomarker outcomes and/or any suitable data. The data can be received through a user interface, uploaded from a local or remote storage device, or in any suitable manner. In particular, the controller no preferably receives a first set of characterization parameters CP1, a first set of actions A1, and a first set of biomarker outcomes BM1 associated with a first person, and further receives a second set of characterization parameters CP2, a second set of actions A2, and a second set of biomarker outcomes BM2 associated with a second person. Furthermore, the controller no is preferably configured to receive third, fourth, and any suitable number of such sets of data. A characterization parameter is preferably any suitable descriptor of a person, such as demographics (e.g., gender, age, weight, ethnicity, geographical location) or life events (e.g., marriage, divorce, death of friend or relative). An action is preferably any suitable action generally in the control of the person, such as diet, medication type and dosage, amount and type of exercise. A biomarker outcome is preferably any suitable measurement of a biological parameter that is produced or created by the body and measured directly, such as level of a particular hormone or blood protein, blood pressure, heart rate, or aerobic capacity.

As shown in FIG. 2A, the analysis engine 120 preferably functions to analyze the received data and determine a biomarker response surface 130 based on the received data. In particular, the analysis engine 120 preferably determines a common set of characterization parameters that are present in both the first and second sets of characterization parameters (i.e., shared between the first and second persons). The analysis engine 120 preferably compares the common set of characterization parameters to a similarity threshold, thereby obtaining a measure of similarity between the first and second persons. For example, the number of elements in the common set of characterization parameters can be compared to a numerical threshold. However, the similarity threshold can be any suitable kind of threshold.

In one variation of the preferred system 100, some of the characterization parameters can be weighted more heavily than others in determining sufficient similarity between the first and second persons. For instance, two people having two shared characterization parameters of age and gender might be considered more similar than two people having two shared characterization parameters of age and ethnicity, if gender is weighted more heavily than ethnicity for purposes of determining similarity between people. The different weighting can be expressed in terms of coefficients, or in any suitable manner.

If the first and second persons are determined to be sufficiently similar based on their common characteristic parameters, then the analysis engine 120 preferably determines a suitable synthetic biomarker response surface 130 fitted to the data corresponding to the first and second persons. The response surface 130 is preferably defined in terms of a multi-dimensional function, as a function of at least a portion of the actions in the first and second sets of actions. The analysis engine 120 preferably uses a suitable regression or other estimation algorithm, such as a method of least squares. In determining a synthetic biomarker response surface 130, the analysis engine 120 preferably weighs at least one action more heavily than another action, such as with a method of weighted least squares. However, the analysis engine 120 can alternatively weigh all actions approximately equally.

As shown in FIG. 2B, in another variation of the preferred system 100, the analysis engine 120 preferably incorporates additional data into the biomarker response surface 130 as new data associated with additional people are received and available. In particular, the analysis engine 120 preferably matches a new person with new data to an existing response surface 130, based on similarity of the new set of characterization parameters CP3 to the common set of characterization parameters corresponding to the existing biomarker response surface 130. The analysis engine 120 can further update the existing biomarker response surface 130 based on the new set of actions A3 and new set of biomarker outcomes BM3. In updating the biomarker response surface 130, the analysis engine 120 preferably incorporates the new data into the biomarker response surface 130, by refitting the response surface 130 function to the larger set of available data. In one embodiment, the analysis engine 120 preferably updates the biomarker response surface 130 by weighing more heavily the previously obtained data that is more similar to the new data. In other words, the analysis engine 120 can update the biomarker response surface 130 according to one or more rules, including: (1) weighing the first set of actions more heavily in updating the biomarker response surface 130, if the first set of biomarker outcomes is more similar than the second set of biomarker outcomes to the third set of biomarker outcomes; and (2) weighing the second set of actions more heavily in updating the biomarker response surface 130, if the second set of biomarker outcomes is more similar than the first set of biomarker outcomes to the third set of biomarker outcomes. In this embodiment, unknown portions of the biomarker response surface 130, that are predicted based on projections from known portions of the biomarker response surface 130, can provide guidance on which portions of previous data are more accurate and can therefore be weighed more heavily to increase accuracy of the biomarker response surface 130. Over a large group of people and their associated sets of data, the biomarker response surface 130 preferably becomes increasingly accurate. In other words, as additional information is available from additional persons relevant to a particular response surface, the method preferably iteratively updates the response surface.

As shown in FIG. 2A, in another variation of the preferred embodiment, the system 100 is configured to create a well-being response surface 130′ as a function of biomarker outcomes, such that the biomarker response surfaces can be used to correlate a set of actions to a well-being response surface 130′. The biomarker response surfaces 130 preferably act as an intermediary, thereby enabling the biomarker response surface 130 to be used as a proxy for optimization of well-being with actions. Since it is often difficult to obtain an accurate measure of the qualitative and subjective aspects of well-being, the biomarker response surface 130 provides a more quantitative shortcut for optimization of well-being. In other words, the biomarker response surface 130 and well-being response surface 130′ can be connected in series so provide shortcuts for optimizing a quality (well-being) on one end of the series.

In this variation of the preferred embodiment, the controller 110 is preferably configured to receive a first set of well-being metric outcomes WB1 associated with the first person and a second set of well-being metric outcomes WB2 associated with the second person. The analysis engine 120 is preferably further configured to determine a well-being response surface 130′ fitted to the first and second well-being metric outcomes as a function of the first and second sets of biomarker outcomes. Similar to determining the biomarker response surfaces, the analysis engine 120 can use any suitable regression or estimation algorithm, and the algorithm can be weighted or unweighted. Furthermore, as shown in FIG. 2B, the analysis engine 120 can incorporate additional well-being metric outcomes WB3 from a new person to update the well-being response surface 130′, similar to the process for updating the biomarker response surface 130.

In another variation of the preferred embodiment, the analysis engine 120 is configured to determine a well-being response surface 130′ as a function of both biomarker outcomes and actions, and more preferably as a function of biomarker outcomes, which have response surfaces that are a function of, or fitted to, actions. For instance, as shown in FIG. 2C, the analysis engine 120 can determine a well-being response surface 130′ as a “nested” function, dependent on the first and second sets of biomarker outcomes, each of which is in turn dependent on the first and second sets of actions.

In other variations of the preferred embodiment, the analysis engine 120 can be configured to create and/or connect other response surfaces in series, thereby forming more complex arrangements of response surfaces. For example, the analysis engine 120 can be configured to create a response surface for one or more of biomarkers, well-being, and/or life score as a function of actions, biomarkers, and/or any suitable qualities. By providing various kinds of response surfaces, the analysis engine preferably enables the use of different matching mechanisms for each set of response surfaces. For instance, a biomarker response surface can be matched to an individual based on the actions of the individual, and a well-being response surface can be matched to an individual based on the characterization parameters and/or biomarker outcomes of the individual.

The preferred system 100 can further include a database 140 on a server or other storage device for storing the received data and/or various response surfaces. The database can, for example, be accessible through one or more user interfaces on a computing device interconnected on a computer network.

### Method for Creating and Maintaining a Response Surface

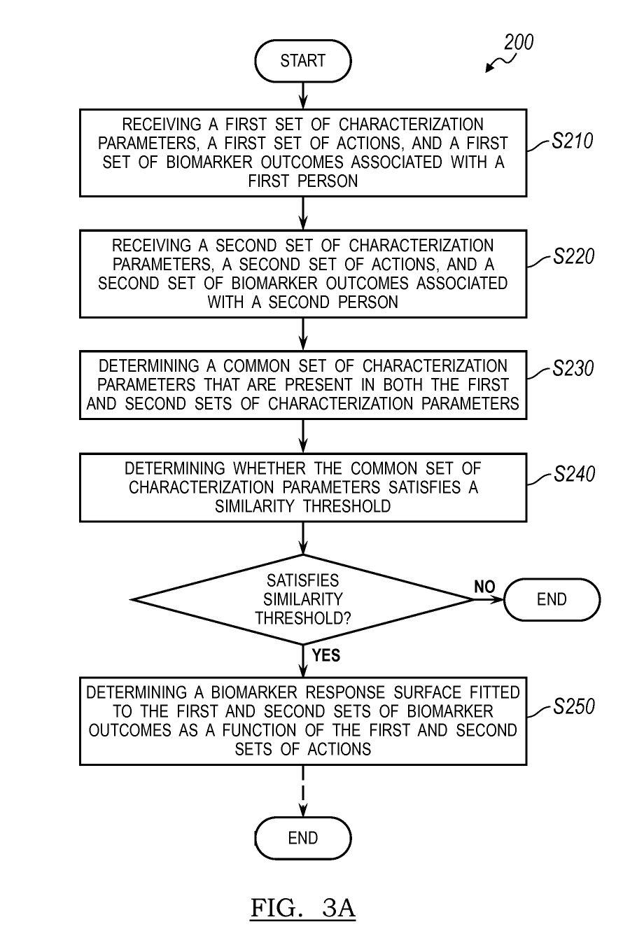

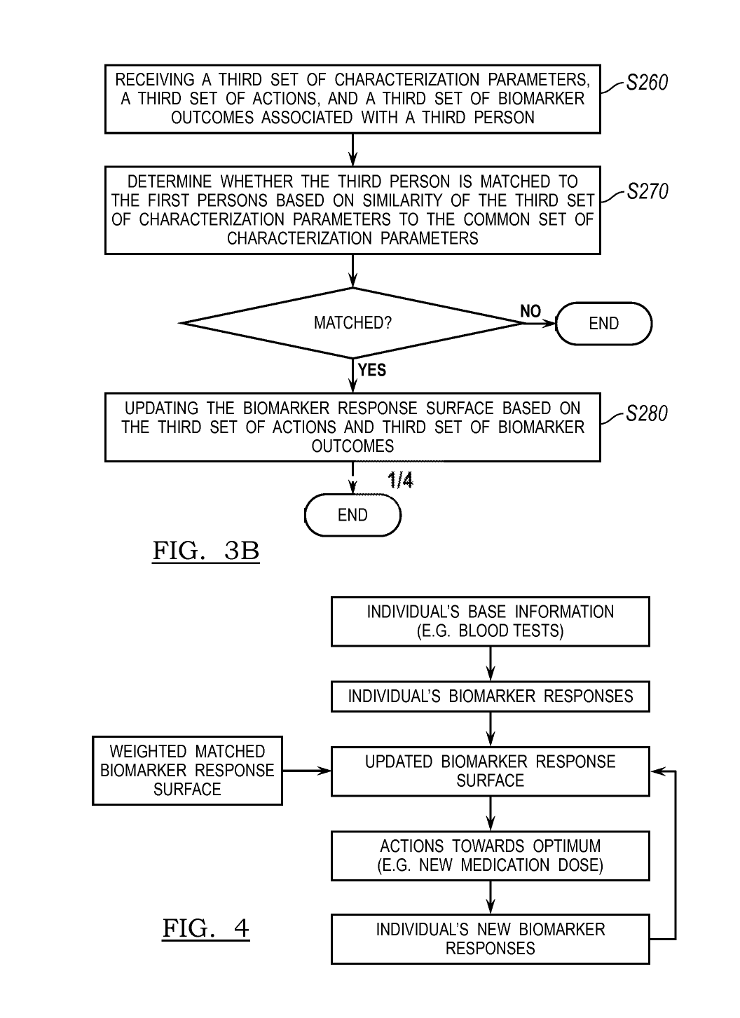

As shown in FIG. 3A, a preferred method 200 for creating and maintaining a response surface includes: in block S210, receiving a first set of characterization parameters, a first set of actions, and a first set of biomarker outcomes associated with a first person; in block S220, receiving a second set of characterization parameters, a second set of actions, and a second set of biomarker outcomes associated with a second person; in block S230, determining a common set of characterization parameters that are present in both the first and second sets of characterization parameters; in block S240, determining whether the common set of characterization parameters satisfies a similarity threshold; and, if the common set of characterization parameters satisfies the similarity threshold, in block S250, determining a biomarker response surface fitted to the first and second sets of biomarker outcomes as a function of the first and second sets of actions. Block S250 of determining the biomarker response surface can include weighing at least one action more heavily than another action.

As shown in FIG. 3A, block S210 recites receiving a first set of characterization parameters, a first set of actions, and a first set of biomarker outcomes associated with a first person. Block S220 recites receiving a second set of characterization parameters, a second set of actions, and a second set of biomarker outcomes associated with a second person. Blocks S210 and S220 preferably function to receive data that can be used to create a response surface. In one embodiment, the data can be received through a user interface, uploaded from a storage device, or in any suitable manner. Furthermore, the method can include receiving any suitable number of sets of data. A characterization parameter is preferably any suitable descriptor of a person, such as demographics (e.g., gender, age, weight, ethnicity, geographical location) or life events (e.g., marriage, divorce, death of friend or relative). An action is preferably any suitable action generally in the control of the person, such as diet, medication type and dosage, amount and type of exercise. A biomarker outcome is preferably any suitable measurement of a biological parameter that is produced or created by the body and measured directly, such as level of a particular hormone or blood protein, blood pressure, heart rate, or aerobic capacity.

As shown in FIG. 3A, block S230 recites determining a common set of characterization parameters that are presented in both the first and second sets of characterization parameters. The method can include one or more of various suitable algorithms to determine the collection of characterization parameters that is common to both the first and second sets (and third or more additional sets associated with additional persons). For example, a simple algorithm performs a search in the second set of characterization parameters for each parameter of the first set of characterization parameters, and stores to a list or set every searched parameter that is found in the second set of characterization parameters. However, any suitable matching or other algorithm can be used to determine a common set of characterization parameters.

As shown in FIG. 3A, block S240 recites determining whether the common set of characterization parameters satisfies a similarity threshold. Block S240 functions to determine whether the first and second persons are suitably similar enough for their respective sets of data to serve as a basis for a biomarker response surface. In determining whether the common set of characterization parameters satisfies a similarity threshold, the method can includes comparing the number of elements in the common set of characterization parameters to a numerical threshold. However, the similarity threshold can be any suitable kind of threshold. In one variation, the method can include weighing at least one characterization parameter more heavily than another characterization parameter. The weighting can be expressed in terms of coefficients, or in any suitable manner.

As shown in FIG. 3A, block S250 recites determining a biomarker response surface fitted to the first and second sets of biomarker outcomes as a function of the first and second sets of actions. Block S250 preferably occurs if the common set of characterization parameters satisfies the similarity threshold in block S240. Block S250 functions to determine a synthetic biomarker response surface corresponding to the first and second persons, and to any further individuals deemed sufficiently similar to the first and second persons. The response surface is preferably defined in terms of a multi-dimensional function, as a function of at least a portion of the actions in the first and second sets of actions. In determining the biomarker response surface, the method preferably uses a suitable regression or other estimation algorithm, such as a method of least squares. The method preferably at least one action more heavily than another action, such as with a method of weighted least squares. However, the method can alternatively weigh all actions approximately equally.

As shown in FIG. 3B, one variation of the preferred method preferably incorporates additional data into the biomarker response surface as new data associated with additional people are received and available. In this variation, the preferred method further includes: block S260, which recites receiving a third set of characterization parameters, a third set of actions, and a third set of biomarker outcomes associated with a third person; block S270, which recites determining whether the third person is matched to the first and second persons based on similarity of the third set of characterization parameters to the common set of characterization parameters; and, if the third set of characterization parameters is matched to the common set of characterization parameters, then block 280 recites updating the biomarker response surface based on the third set of actions and third set of biomarker outcomes. Block S260 is preferably similar to blocks S210 and S220, except that block S260 receives data regarding a third additional person. As shown in FIG. 4, the third person can be an individual under treatment or performing actions guided by a biomarker response surface matched to that individual. As additional information is available from additional persons relevant to a particular response surface, the method preferably iteratively updates the response surface.

As shown in FIG. 3B, block S270 recites matching the third person to the first and second persons based on similarity of the third set of characterization parameters to the common set of characterization parameters. Block S270 preferably functions to match the third person to an existing response surface, thereby identifying the third set of data as suitable as a basis for updating the existing response surface.

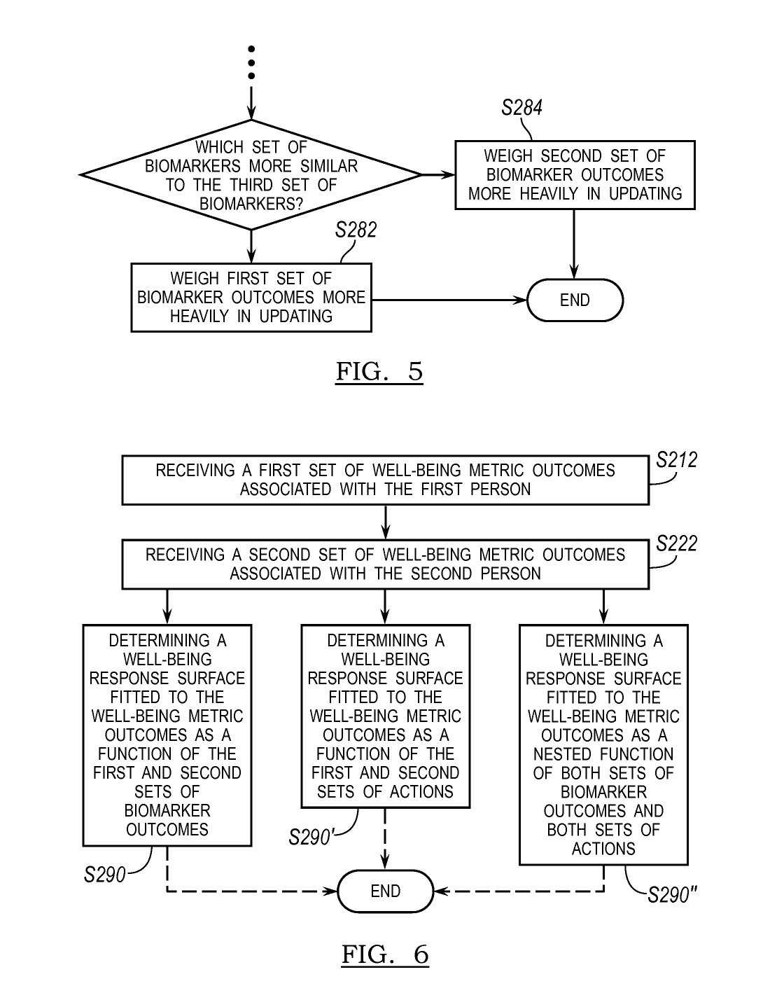

As shown in FIG. 3B, block S280 recites updating the biomarker response surface based on the third set of actions and third set of biomarker outcomes. In updating the biomarker response surface, the method preferably incorporates the new data into the biomarker response surface, by refitting the response surface function to the larger set of available data. In one embodiment, the method preferably updates the biomarker response surface by weighing more heavily the previously obtained data that is more similar to the new data. As shown in FIG. 5, block S280 of the preferred method can update the biomarker response surface according to one or more rules, including: (1) in block S282, weighing the first set of actions more heavily in updating the biomarker response surface, if the first set of biomarker outcomes is more similar than the second set of biomarker outcomes to the third set of biomarker outcomes; and (2) in block S284, weighing the second set of actions more heavily in updating the biomarker response surface, if the second set of biomarker outcomes is more similar than the first set of biomarker outcomes to the third set of biomarker outcomes. In this variation of the preferred method, unknown portions of the biomarker response surface, that are predicted based on projections from known portions of the biomarker response surface, can provide guidance on which portions of previous data are more accurate and can therefore be weighed more heavily to increase accuracy of the biomarker response surface. Over a large group of people and their associated sets of data, the biomarker response surface preferably becomes increasingly accurate.

As shown in FIG. 6, another variation of the preferred method 200 is configured to create a well-being response surface as a function of biomarker outcomes, such that the biomarker response surfaces can be used to correlate a set of actions to a well-being response surface. The biomarker response surfaces preferably act as an intermediary, thereby enabling the biomarker response surface to be used as a proxy for optimization of well-being with actions. Since it is often difficult to obtain an accurate measure of the qualitative and subjective aspects of well-being, the biomarker response surface provides a more quantitative shortcut for optimization of well-being. In other words, the biomarker response surface and well-being response surface can be connected in series so provide shortcuts for optimizing a quality (well-being) on one end of the series.

The variation of the preferred method shown in FIG. 6 preferably includes: in block S212, receiving a first set of well-being metric outcomes associated with the first person; in block S222, receiving a second set of well-being metric outcomes associated with the second person; and in block S290, determining a well-being response surface fitted to the well-being metric outcomes as a function of the first and second sets of biomarker outcomes. In a preferred variation, the method additionally or alternatively includes block S290′, which recites determining a well-being response surface fitted to the well-being metric outcomes as a function of the first and second sets of actions. Blocks S212 and S222 are preferably similar to blocks S210 and S220, respectively. Blocks S290 and S290′ are preferably similar to block S250, in that similar to determining the biomarker response surface, the blocks S290 and S290′ can use any suitable regression or estimation algorithm, and the algorithm can be weighted or unweighted.

The variation of the preferred method shown in FIG. 6 can additionally or alternatively include block S290″, which recites determining a well-being response surface fitted to the well-being metric outcomes as a function of both biomarker outcomes and actions, and more preferably as a function of biomarker outcomes, which have response surfaces that are a function of, or fitted to, actions. For instance, the method can determine a well-being response surface that is a “nested” function, dependent on the first and second sets of biomarker outcomes, each of which is in turn dependent on the first and second sets of actions. By providing various kinds of response surfaces, the method preferably enables the use of different matching mechanisms for each set of response surfaces. For instance, a biomarker response surface can be matched to an individual based on the actions of the individual, and a well-being response surface can be matched to an individual based on the characterization parameters and/or biomarker outcomes of the individual.

In other variations, the preferred method 200 can create and/or connect other response surfaces in series, thereby forming more complex arrangements of response surfaces. For example, the method can create a response surface for one or more of biomarkers, well-being, and/or life score as a function of actions, biomarkers, and/or any suitable qualities. Integrated component response surfaces preferably reflect the effects of actions, biomarker outcomes, and well-being metric outcomes. Such response surfaces add information to the relationship between actions (and/or events) and components of life score. These relationships can help create better composite response surfaces from matched individuals (i.e., those with sufficiently similar characteristic parameters) because more information is available to match.

### EXAMPLES

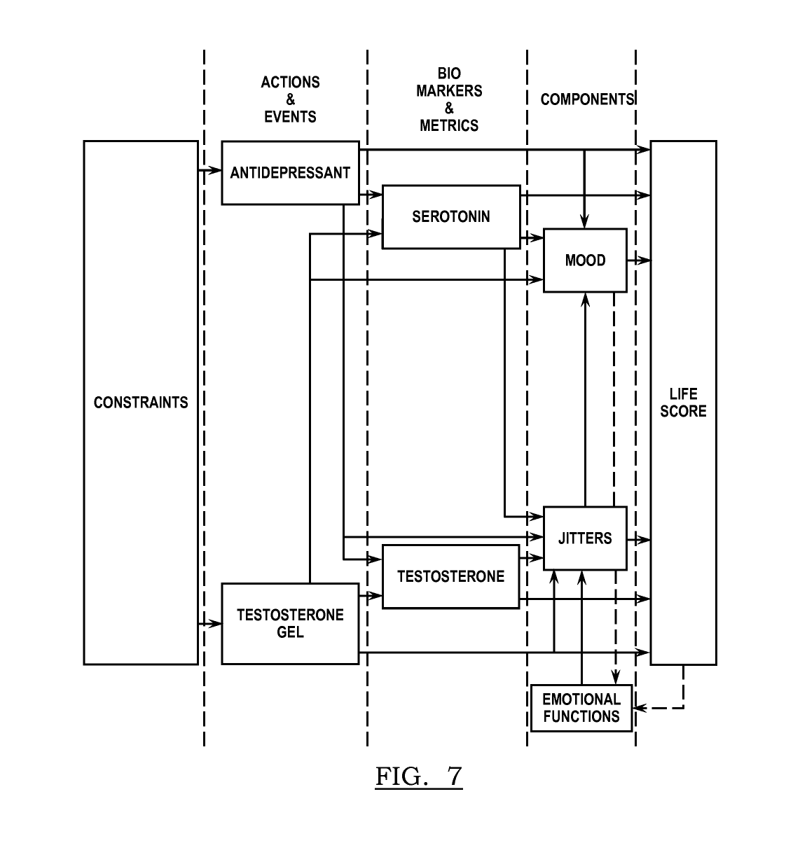

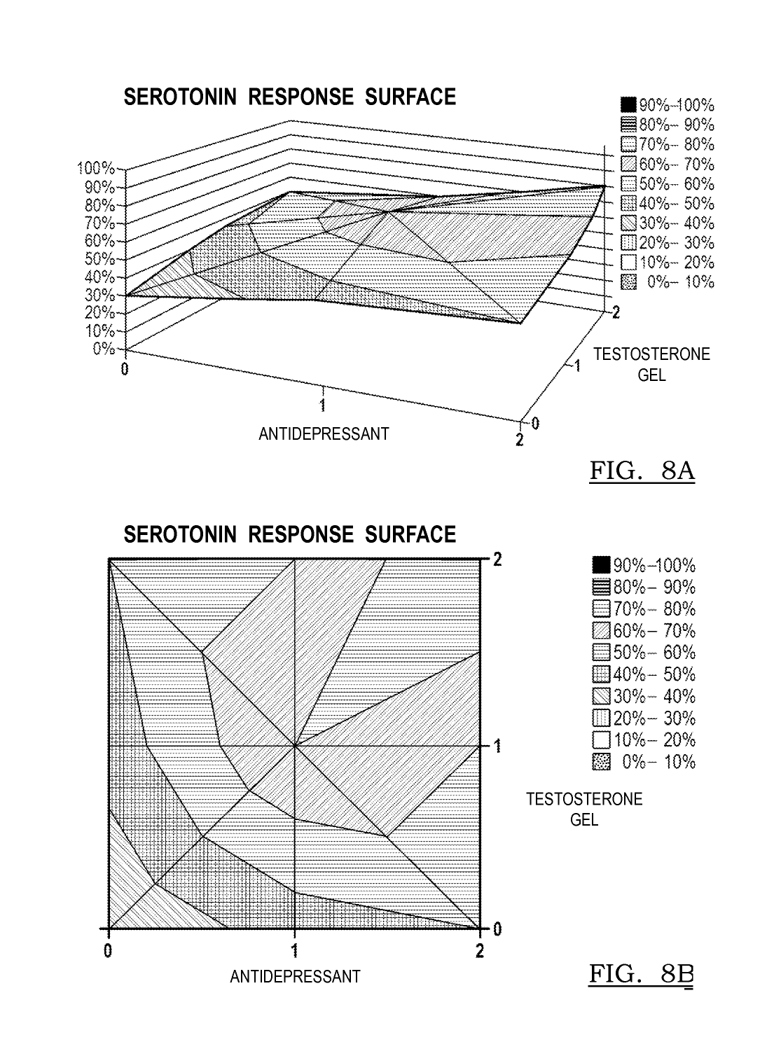

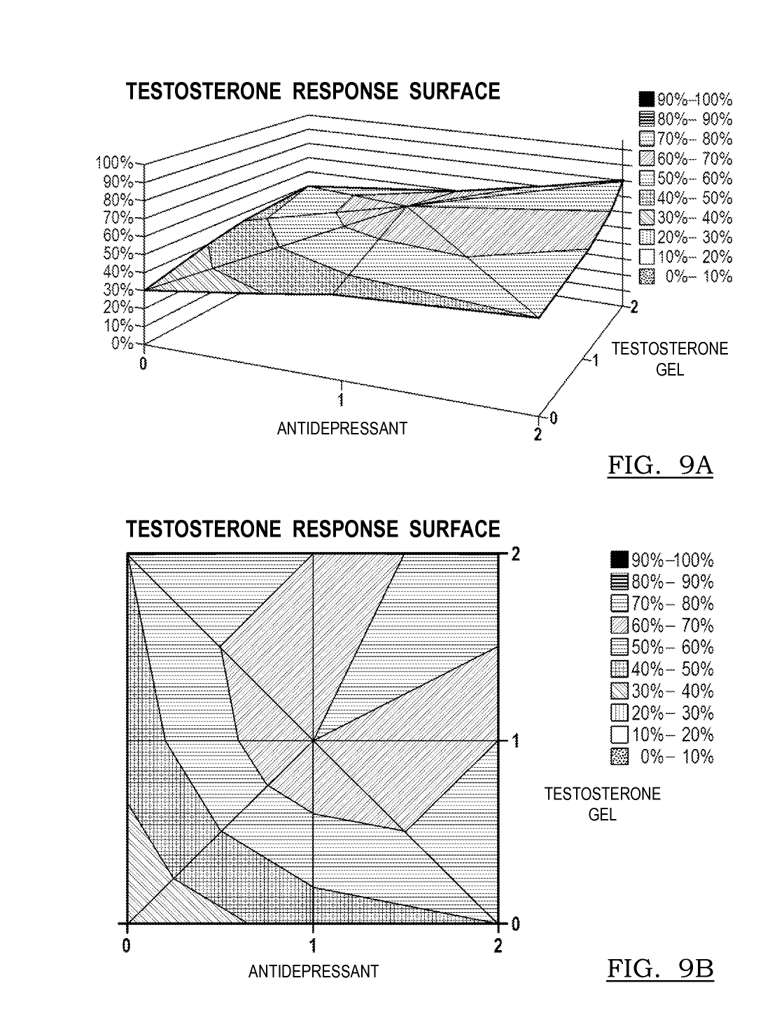

The following example implementations of the preferred systems and methods are for illustrative purposes only, and should not be construed as definitive or limiting of the scope of the claimed invention. In one example, as shown in FIG. 7, the life optimization system is applicable to a person who suffers from depression. Treatment courses of two medications, an antidepressant and testosterone gel (e.g., Testim®), are considered as actions that attempt to mitigate depression, among other actions such as exercise and cognitive therapy. The actions affect two biomarkers: serotonin (which is related to mood and anxiety) and testosterone (which is related to many male outcomes such as depression and sex drive). This relationship between the actions and biomarkers is illustrated in the exemplary biomarker response surfaces of FIGS. 8A and 8B for serotonin response and FIGS. 9A and 9B for testosterone response. In addition to antidepressants and testosterone gel, the serotonin and testosterone response surfaces might additionally or alternatively be a function of exercise, meditation, stress, and other suitable actions.

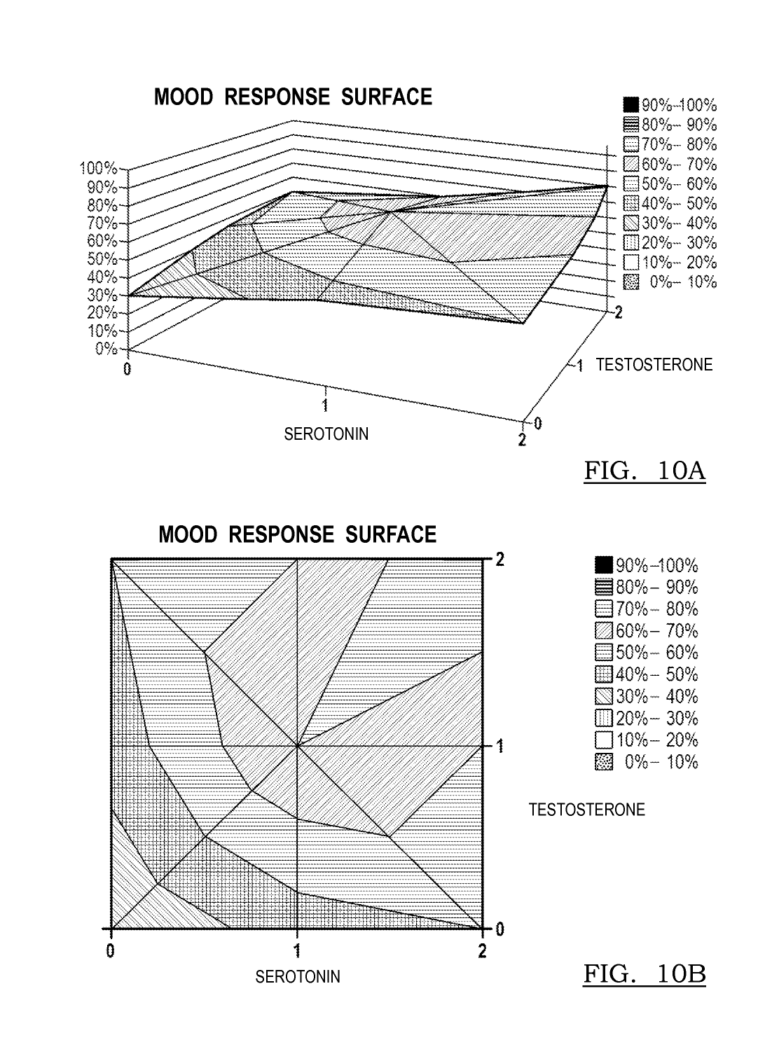

The actions and subsequent biomarker levels further affect two well-being metrics that contribute to the life gauge and lifetime components of life score: mood (that can be a measure of depression) and “jitters” (that can be used to refer to a general group of side effects resulting from excessive serotonin and/or testosterone). At least two well-being response surfaces can be modeled as a function of the biomarker levels of serotonin and testosterone levels. For example, FIGS. 10A and 10B show an exemplary illustrative mood response surface and FIGS. 11A and 11B show an exemplary illustrative jitters response surface. Other versions of well-being response surfaces can be modeled as a function of the actions of taking certain doses of antidepressant and testosterone gel.

The relationships shown in FIG. 7 between actions/events, biomarkers, and well-being components enable the creation of multiple or integrated response surfaces reflecting those relationships, including (1) mood response surface as a function of antidepressant dose, Testim® dose, serotonin level, and/or testosterone level, and (2) jitters response surface as a function of antidepressant dose, Testim® dose, serotonin level, and/or testosterone level.

In this example, happier mood and lack of jitters are assumed to contribute to higher life gauge as well as longer lifetime due to better sleep. In other words, life score is a function of the actions taken by the individual. A series of experiments can develop a multi-dimensional life score response surface modeled as a function of doses of the antidepressant and testosterone gel.

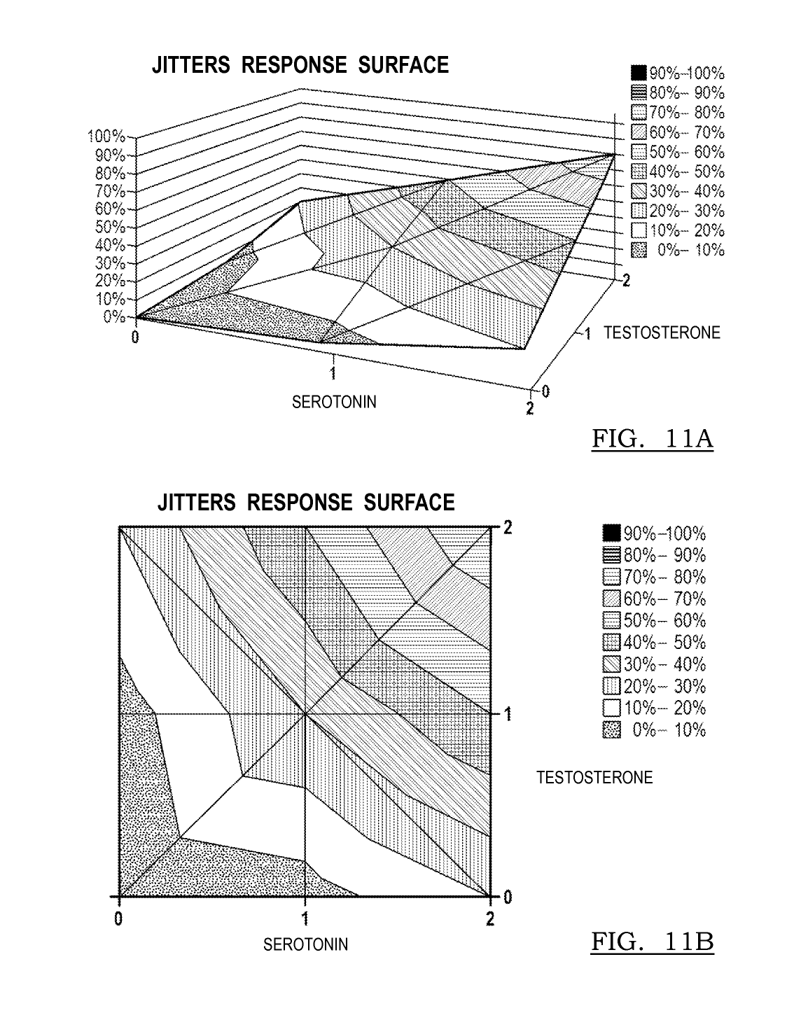

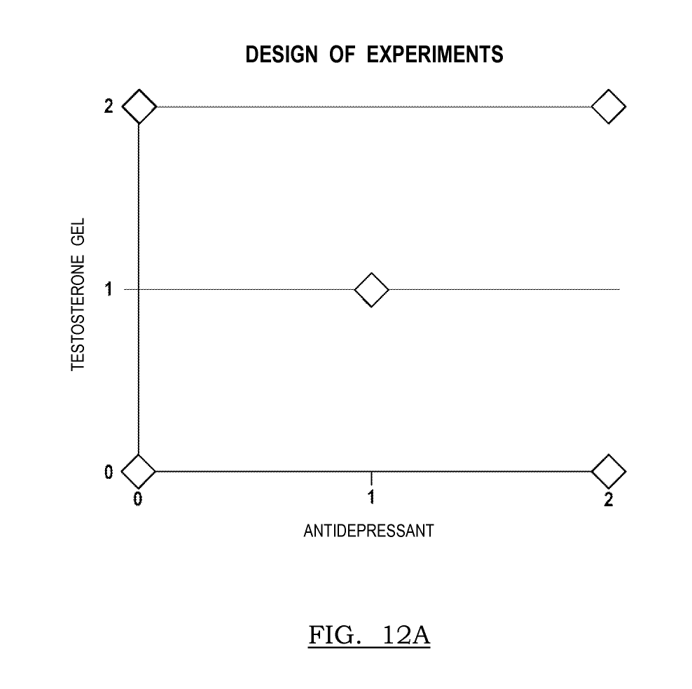

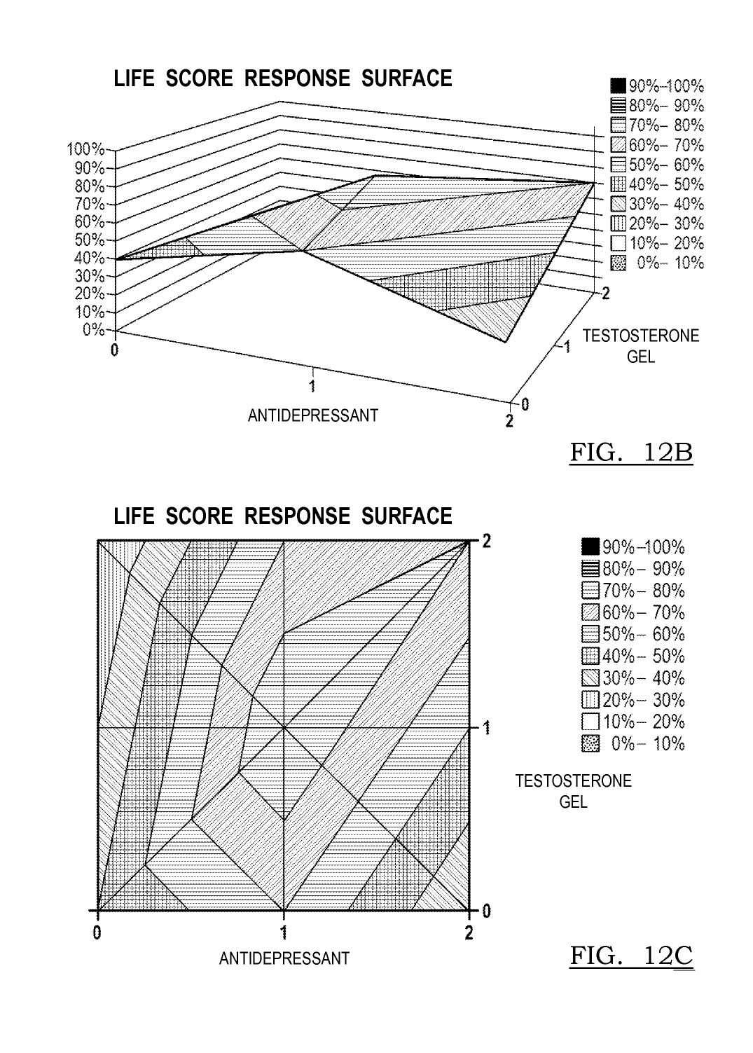

As shown in FIG. 7, the life gauge component of life score responds to at least two actions: doses of antidepressant and doses of testosterone gel. FIG. 12A shows a typical design of experiments to define the life score response surface in response to the actions: (1) antidepressant dose takes three values (0, 1, 2), which for other actions could be level of exercise activity or generally a measure of the extent of the action, and (2) testosterone gel dose takes three values (o, 1, 2). An exemplary life score response surface resulting from these experiments might be similar to that shown in FIGS. 12B and 12C. This illustrative life score response surface defines a maximum life score is near level 1 for the antidepressant and level 2 for testosterone gel, and a high life score/well-being ridge from the peak to level 2 for the antidepressant and level 2 for the testosterone gel.

### System for Using a Response Surface

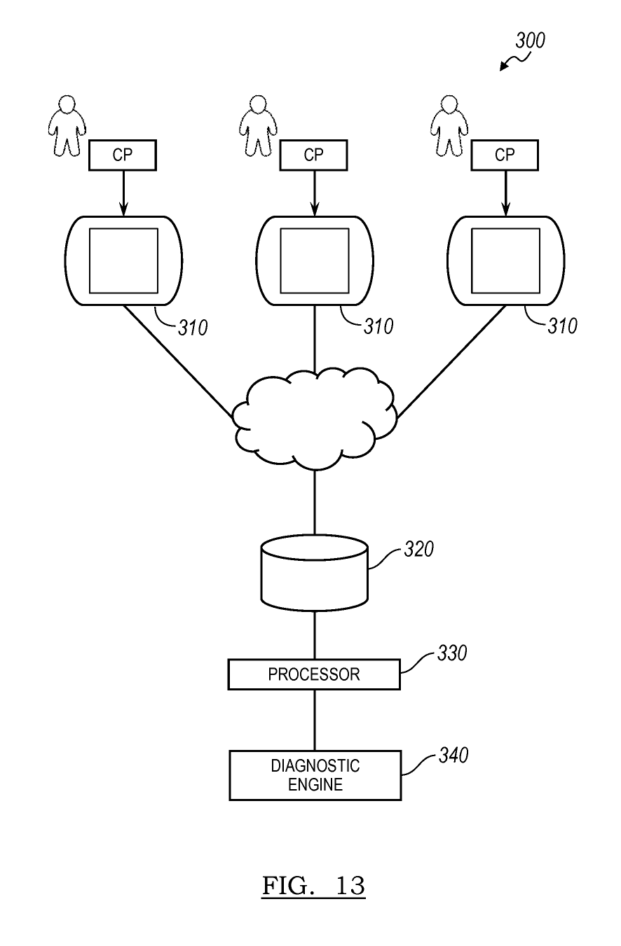

As shown in FIG. 13, a preferred embodiment of a system 300 for using a response surface includes: a user interface 310 configured to receive a set of characterization parameters associated with a patient and to query a database 320 that stores a plurality of biomarker response surfaces; a processor 330 configured to receive an applicable biomarker response surface based on the characterization parameters associated with the patient; and a diagnostic engine 340 configured to provide a treatment option for the patient based on a maximum point of the applicable biomarker response surface. Each biomarker response surface preferably models the biomarker response as a function of actions (e.g., medication dosage) that a particular kind of patient can take. Each biomarker response surface preferably corresponds to a patient population with a set of common characterization parameters, such that the processor 330 receives an applicable biomarker response surface corresponding to a matching patient population whose set of common characterization parameters is substantially similar to the set of characteristic parameters associated with the patient. Response surfaces from matched patient populations allow prediction of an optimal starting point at the beginning of a life optimization process and to predict response to new actions (e.g., treatment options).

As shown in FIG. 13, the user interface 310 preferably functions to receive data associated with a patient and to communicate with a database 320 storing a plurality of biomarker response surface. The user interface 310 is preferably displayed on a computing device (e.g., desktop or laptop computer, mobile phone device, tablet computer) that can be connected to a computer network for communicating with the database 320. However, the user interface 310 can alternatively be displayed on a standalone computing device having a storage device that stores the database 320. The user interface is preferably configured to interface with a medical practitioner (e.g., physician, psychiatrist, therapist) but can additionally or alternatively be configured to interface directly with a patient or other suitable user. The user interface 310 is preferably a web-based interface, but can alternatively be implemented in a software application. In a preferred embodiment, the user interface 310 includes an application programming interface (API), which can be used to target and retrieve particular types of data, including stored biomarker response surfaces and their corresponding common characterization parameters. The API is preferably a web API such as a Representational State Transfer (REST) style API or Simple Object Access Protocol (SOAP) style API, but can alternatively be any suitable type of API.

As shown in FIG. 13 the user interface 310 can include designated areas or functions for receiving particular characterization parameters or other suitable information, such as file uploads, text fields, radio buttons, checkboxes, or any suitable interface. The user interface 310 can receive characterization parameters of demographics such as age, weight, and/or gender, and/or other information particular to the patient such as genetic profiles, biomarker profiles, personal health records, diet and exercise records, results of a health physical, personality type assessment, life or emotional questionnaires, and/or any suitable information. The user interface 310 preferably sends a match query to the database 320 or storage device storing the biomarker response surfaces, in which the match query includes at least a portion of the received characterization parameters and other information.

As shown in FIG. 13, the processor 330 preferably functions to receive a biomarker response surface that is suitable for the patient. The processor 330 (or another processor coupled to the database 320) preferably analyzes the characterization parameters, determines a matching patient population whose set of common characterization parameters is substantially similar to the set of characterization parameters associated with the patient, and provides the biomarker response surface corresponding to the matching patient population. In determining a matching patient population, the processor 330 preferably compares the queried set of characterization parameters to a similarity threshold. For example, the number of common characterization parameters of a potentially matching patient population that is present in the set of characterization parameters of the patient can be compared to a numerical threshold. However, the similarity threshold can be any suitable kind of threshold. In one variation, some of the characterization parameters can be weighted more heavily than others in determining sufficient similarity between the patient and a potentially matching patient population. For instance, a matching weight can be weighted more heavily than matching age. The different weighting can be expressed in terms of coefficients, or in any suitable manner.

As shown in FIG. 13, after determining a matching patient population, the processor 330 preferably provides, to the diagnostic engine 340, the biomarker response surface corresponding to the matching patient population. In one embodiment, the processor 330 can communicate the biomarker response surface to the user interface 310 for a graphical or other suitable display of the response surface function.

As shown in FIG. 13, the diagnostic engine 340 preferably functions to locate a local and/or absolute maximum point on the biomarker response surface, and to provide a treatment option for the patient based on the maximum point. In locating a maximum point on the biomarker response surface, the diagnostic engine 340 preferably optimizes a treatment option or plan of action for the patient. In one variation, the diagnostic engine 340 determines and provides at least one treatment option or other action that corresponds to the maximum point on the biomarker response surface. For instance, the diagnostic engine 340 can suggest a change in type, dose or frequency of a medication, a change in diet, a change in exercise habits, a change in physical or mental therapy, and/or any suitable action or other treatment option. In another variation, the diagnostic engine 340 determines and provides at least one treatment option or other action that approaches an action that corresponds to the maximum point on the biomarker response surface. In a preferred variation, particularly if the response surface is well-behaved, the diagnostic engine 340 can suggest a series of sequential actions, determined with a “hill-climbing” algorithm, that progressively move the patient towards the action or actions corresponding to the maximum point on the biomarker response surface. Depending on how the patient responds to each of the actions, the diagnostic engine 340 can provide an adjusted series of sequential actions to reorient the patient towards the maximum point on the response surface. In some cases, the system 300 may query the database 320 and receive a new or updated response surface that is more applicable to the patient, as more information is gathered about the patient.

In another variation of the preferred embodiment, the system 300 can query and receive a “nested” well-being response surface as a function of biomarker outcomes and actions, in that the well-being response surface is dependent on biomarker outcomes, each of which is in turn dependent on actions. In instances in which a patient does not have a well-defined personal well-being response surface (but does have sufficiently well-defined biomarker response surfaces based on actions), the processor 330 can retrieve a matching nested well-being response surface (that is a function of biomarker outcome variables) that is suitable for the patient based on his or her characterization parameters, and then retrieve at least one matching biomarker response surface (that is a function of actions) that is suitable for the patient based on his or her biomarker outcomes. In this variation, the diagnostic engine 340 can locate a maximum point on the nested well-being response surface and provide a treatment option based on the located maximum point, similar the process for a biomarker response surface.

In one preferred embodiment, the system 300 can query and receive any suitable response surface, such as a well-being response surface as a function of biomarker outcomes and/or actions, or a life score response surface as function of well-being metrics, biomarker outcomes and/or actions.

### Method for Using a Response Surface

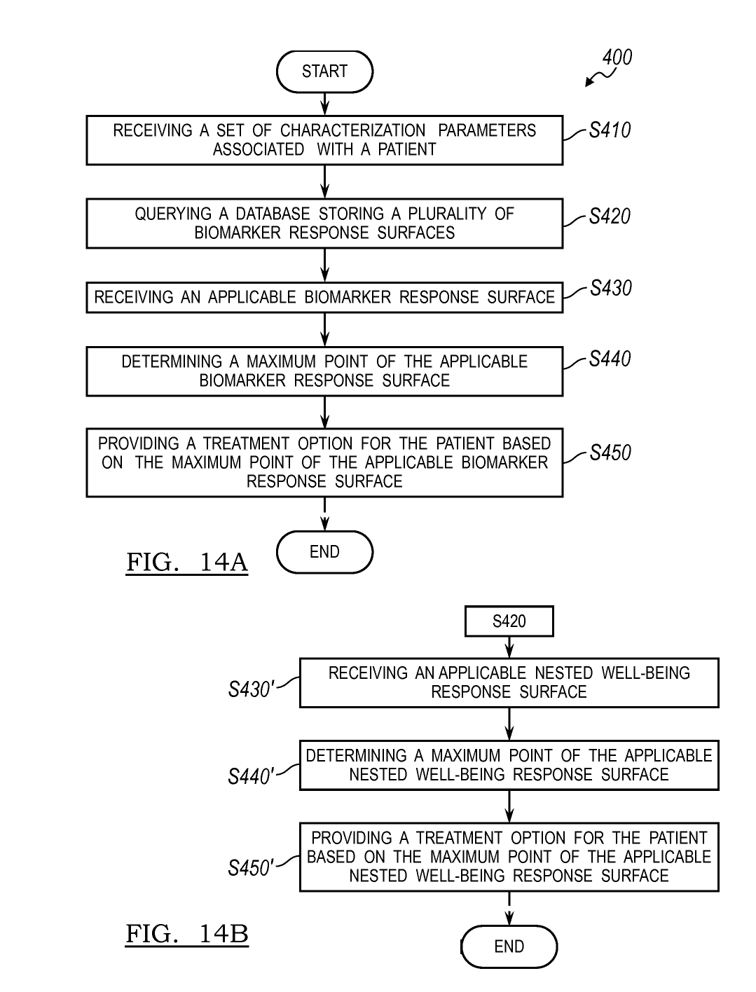

As shown in FIG. 14A, a preferred embodiment of a method 400 for using a response surface includes: in block S410, receiving a set of characterization parameters associated with a patient; in block S420, querying a database storing a plurality of biomarker response surfaces; in block S430, receiving an applicable biomarker response surface; in block 440, determining a maximum point of the applicable biomarker response surface; and in block S450, providing a treatment option for the patient based on the maximum point of the applicable biomarker response surface. Each biomarker response surface preferably models the biomarker response as a function of actions (e.g., medication dosage) that a particular kind of patient can take. Each biomarker response surface preferably corresponds to a patient population with a set of common characterization parameters, and the applicable biomarker response preferably corresponds to a matching patient population whose set of common characterization parameters is substantially similar to the set of characterization parameters associated with the patient. Response surfaces from matched patient populations allow prediction of an optimal starting point at the beginning of a life optimization process and to predict response to new actions (e.g., treatment options).

As shown in FIG. 14A, block S410 recites receiving a set of characterization parameters associated with a patient. Block S410 preferably functions to receive data about the patient. The information can be received through a user interface, through upload or file transfer from a storage device, and/or in any suitable interface. In one preferred embodiment, the characterization parameters are received through a web-based interface or API on a computing device connected to a computer network. The received characterization parameters can include demographics such as age, weight, and/or gender, and/or other information particular to the patient such as genetic profiles, biomarker profiles, personal health records, diet and exercise records, results of a health physical, personality type assessment, life or emotional questionnaires, and/or any suitable information.

As shown in FIG. 14A, block S420 recites querying a database storing a plurality of biomarker response surfaces. Block S420 functions to initiate a match analysis for the patient. The query is preferably made over a computer network (e.g., internet) or in any suitable manner. The query preferably includes at least a portion of the received characterization parameters and any other information about the patient, and can be formatted in any suitable string or other manner.

As shown in FIG. 14A, block S430 recites receiving an applicable biomarker response surface. The applicable biomarker response surface preferably corresponds to a matching patient population whose set of common characterization parameters is substantially similar to the queried set of characterization parameters associated with the patient. For example, a set of common characterization parameters can be considered substantially similar to the queried set of characterization parameters if the number of parameters shared between the set of common characterization parameters and the queried set of characterization parameters of the patient satisfies a similarity threshold (e.g., a numerical threshold). In one variation, some of the characterization parameters can be weighted more heavily than others in determining sufficient similarity between the patient and a potentially matching patient population. In one embodiment, the method 400 includes displaying the applicable biomarker response surface, such as on a user interface or other suitable display on a computing device.

As shown in FIG. 14A, block S440 recites determining a maximum point of the applicable biomarker response surface. Block S440 functions to locate an area of the response surface corresponding to an optimized treatment option or plan or action for the patient. The maximum point can be an absolute maximum or a local maximum of the response surface, and can be determined through a hill-climbing algorithm or any suitable maximum-finding algorithm.

As shown in FIG. 14A, block S450 recites providing a treatment option for the patient based on a maximum point of the applicable biomarker response surface. In one variation, the method 400 provides at least one treatment option or other action that corresponds to the maximum point on the biomarker response surface. For instance, block S450 can include suggesting a change in type, dose or frequency of a medication, a change in diet, a change in exercise habits, a change in physical or mental therapy, and/or any suitable action or other treatment option. In another variation, the method 400 provides at least one treatment option or other action that approaches an action that corresponds to the maximum point on the biomarker response surface. In a preferred variation, particularly if the response surface is well-behaved, block S450 can suggest a series of sequential actions, determined with a “hill-climbing” algorithm, that progressively move the patient towards the action or actions corresponding to the maximum point on the biomarker response surface. Depending on how the patient responds to each of the actions, the method 400 can provide an adjusted series of sequential actions to reorient the patient towards the maximum point on the response surface. In some cases, the method 400 may include querying and receiving a new or updated response surface that is more applicable to the patient, as more information is gathered about the patient.

As shown in FIG. 14B, in another variation of the preferred embodiment, the method can include receiving an applicable “nested” well-being response surface in block S430′, determining a maximum point of the applicable nested well-being response surface in block S440′, and providing a treatment option for the patient based on the maximum point of the applicable nested well-being response surface in block S450′. The “nested” well-being response surface is preferably a function of biomarker outcomes and actions, in that the well-being response surface is dependent on biomarker outcomes, each of which is in turn dependent on actions. In instances in which a patient does not have a well-defined personal well-being response surface (but does have sufficiently well-defined biomarker response surfaces based on actions), the applicable nested well-being response surface is preferably suitable for the patient based on his or her characterization parameters. The method can further include retrieving at least one matching biomarker response surface (that is a function of actions) that is suitable for the patient based on his or her biomarker outcomes. In this variation, blocks S440′ and S450′ regarding nested well-being response surfaces are preferably similar to block S440 and S450 for biomarker response surfaces, respectively.

In one preferred embodiment, the method 400 may query and receive any suitable response surface, such as a well-being response surface as a function of biomarker outcomes and/or actions, or a life score response surface as function of well-being metric outcomes, biomarker outcomes and/or actions.

### Examples

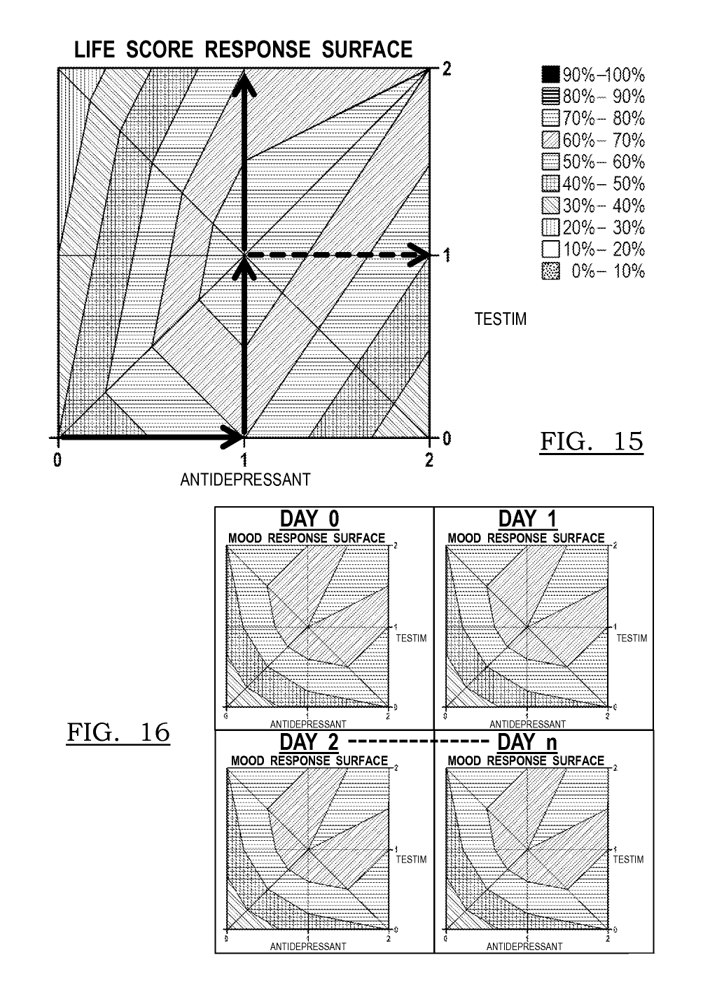

The following example implementations of the preferred systems and methods are for illustrative purposes only, and should not be construed as definitive or limiting of the scope of the claimed invention. Optimization through sequential steps is possible for a well-behaved response surface such as the life score response surface of FIG. 15. For example, a simple hill-climbing algorithm with big steps might start with no actions (antidepressant and testosterone gel dosage at level 0). A first action might include increasing antidepressant dosage to level 1, and result in a measurable life score increase. A second action might include increasing testosterone dosage to level 1, while maintaining antidepressant dosage at level 1, and result in another measurable life score increase. A third action might include further increasing antidepressant dosage to level 2, while maintaining testosterone dosage at level 1, and result in a measurable life score decrease. A fourth action might reverse the third action (returning antidepressant dosage to level 1) and increase testosterone dosage to level 2, and result in another measurable life score decrease. The hill-climbing algorithm might stop at an assumed sufficient maximum point of antidepressant level 1 and testosterone level 1, or might take smaller steps in various directions along the response surface until a sufficient maximum has been reached for the patient.

### Dynamic Response Surfaces

Most actions, including medications, take time to achieve their full effect for various outcomes in biomarkers, well-being, life score, and other metrics. Dynamic response surfaces 500 preferably incorporate a temporal dimension, to capture these dynamic aspects of a response to an action. Dynamic response surfaces can be multi-dimensional in several ways (e.g., one outcome such as mood as a function of two action variables such as antidepressant and testosterone gel; two or more outcomes such as mood and jitters as a function of one action variable such as antidepressant; two or more outcomes such as mood and jitters as a function of two or more action variables such as antidepressant and testosterone gel). As shown in FIG. 16 a dynamic response surface 500 is preferably a time-dependent series of static response surfaces. In other words, there is a dynamic response surface 500 that incorporates the time dimension for every static response surface.

Dynamic response surfaces, incorporating trend estimation algorithms and the experiences of other matching individuals (e.g., with a similar common set of characteristic parameters), can enable a medical practitioner or other user estimate the full or maximum effect of an action in advance. For example, in the illustrative example shown in FIG. 17, a one-dimensional dynamic response surface plots or models the well-being metric outcome over time, beginning at the start of a treatment course of a medication such as an antidepressant. In this example, the dynamic well-being response surface predicts that the treatment increases well-being with diminishing returns over time, following an exponential function that asymptotically reaches a maximum level of well-being. Dynamic response surfaces can expedite life optimization. For example, using knowledge gathered from a dynamic well-being response surface, it can be possible to estimate the full effect of the treatment course at day 50 of the treatment course, based on data obtained at day 25.

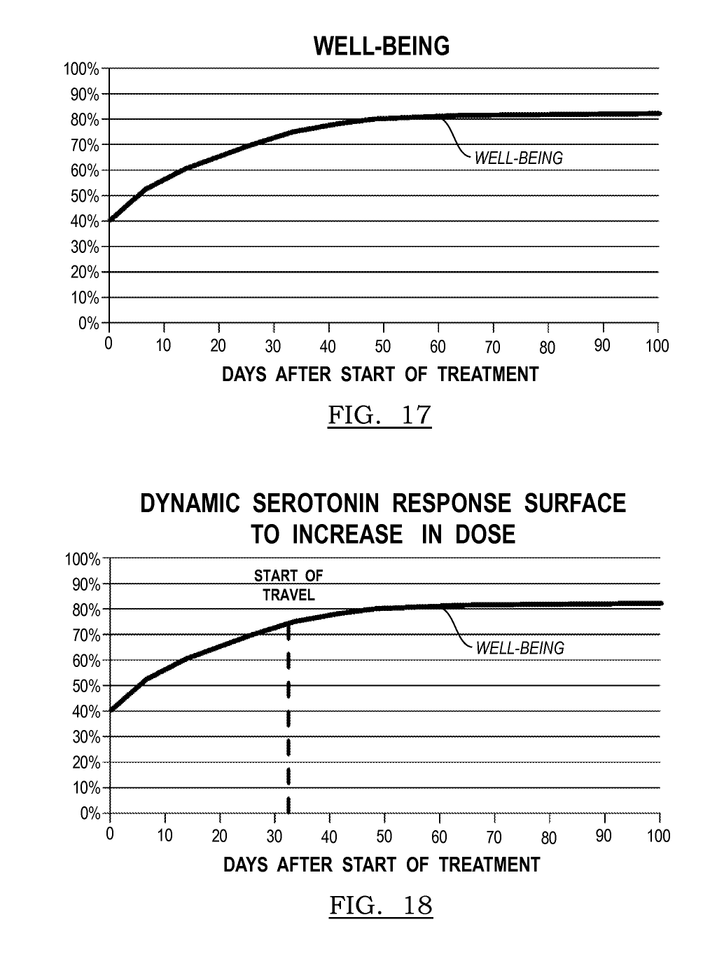

Dynamic response surfaces 500 can be used in anticipatory treatment of life events. In one illustrative example of use of a dynamic response surface, an individual might anticipate increased stress from a job that requires additional travel beginning on a particular initial travel date. The individual would like to increase dose levels of antidepressant in advance of the initial travel date, in an effort to optimize his serotonin level, and therefore well-being, during travel. The exemplary dynamic serotonin response surface shown in FIG. 18 can help determine how far in advance of the initial travel date the individual should increase his antidepressant dosage. An acceptable treatment option for well-being optimization might be to increase antidepressant dosage approximately 32 days prior to the initial travel date, such that the individual is expected to have approximately 75% of the maximum effect of increased serotonin (and increased well-being) at the beginning of his travels.

The systems and methods of the preferred embodiment and variations thereof can be performed by a system and/or computer program product embodied in a computer-readable medium storing computer-readable instructions. Any computer-readable instructions are preferably executed by computer-executable components integrated with at least one computing device and/or server. Suitable computing devices can include a personal computer, laptop computer, a tablet computer, a smart phone, or any suitable computing device. Suitable servers can include a local server, a personal computer, server cluster, or any suitable storage device or combination thereof. The computer-readable medium can be stored on any suitable computer readable medium such as RAMs, ROMs, flash memory, EEPROMs, optical devices (CD or DVD), hard drives, floppy drives, or any suitable device. The computer-executable medium is preferably a processor, but any suitable dedicated hardware device can additionally or alternatively execute the instructions.

As a person skilled in the art will recognize from the previous detailed description and from the figures and claims, modifications and changes can be made to the preferred embodiments of the invention without departing from the scope of this invention defined in the following claims.

What is claimed is:

1. A system comprising:
a controller configured to receive:
a first set of characterization parameters, a first set of actions, and a first set of biomarker outcomes associated with a first person; and
a second set of characterization parameters, a second set of actions, and a second set of biomarker outcomes associated with a second person; and
an analysis engine communicatively coupled to the controller and configured to:
determine a common set of characterization parameters that are present in both the first and second sets of characterization parameters; and
if the common set of characterization parameters satisfies a similarity threshold, determine a biomarker response surface fitted to the first and second sets of biomarker outcomes as a function of the first and second sets of actions, wherein in determining the biomarker response surface, the analysis engine weighs at least one action more heavily than another action.

2. The system of claim 1, wherein:
the controller is configured to receive a third set of characterization parameters, a third set of actions, and a third set of biomarker outcomes associated with a third person; and
the analysis engine is configured to match the third person to the first and second persons based on similarity of the third set of characterization parameters to the common set of characterization parameters, and to update the biomarker response surface based on the third set of actions and third set of biomarker outcomes.

3. The system of claim 2, wherein in updating the biomarker response surface, the analysis engine is configured to update based on the following rules:
weighing the first set of actions more heavily in updating the biomarker response surface, if the first set of biomarker outcomes is more similar than the second set of biomarker outcomes to the third set of biomarker outcomes; and
weighing the second set of actions more heavily in updating the biomarker response surface, if the second set of biomarker outcomes is more similar than the first set of biomarker outcomes to the third set of biomarker outcomes.

4. The system of claim 2, wherein:
the controller is configured to receive a first set of well-being metric outcomes associated with the first person and a second set of well-being metric outcomes associated with the second person; and
the analysis engine is configured to determine a well-being response surface fitted to the first and second well-being metric outcomes as a function of the first and second sets of biomarker outcomes.

5. The system of claim 4, wherein the analysis engine is configured to determine a well-being response surface fitted to the first and second well-being metric outcomes as a function of the first and second sets of actions.

6. A method comprising:
receiving a first set of characterization parameters, a first set of actions, and a first set of biomarker outcomes associated with a first person;
receiving a second set of characterization parameters, a second set of actions, and a second set of biomarker outcomes associated with a second person;
determining, with a processor of a computing device, a common set of characterization parameters that are present in both the first and second sets of characterization parameters;
determining whether the common set of characterization parameters satisfies a similarity threshold; and
if the common set of characterization parameters satisfies the similarity threshold, determining, with the processor, a biomarker response surface fitted to the first and second sets of biomarker outcomes as a function of the first and second sets of actions, wherein determining the biomarker response surface comprises weighing at least one action more heavily than another action.

7. The method of claim 6, wherein each set of actions comprises administration of a particular dosage of a particular medication.

8. The method of claim 7, wherein each set of biomarker outcomes comprises a biologic indicator determined from a blood test.

9. The method of claim 6, further comprising:
receiving a third set of characterization parameters, a third set of actions, and a third set of biomarker outcomes associated with a third person;
matching the third person to the first and second persons based on similarity of the third set of characterization parameters to the common set of characterization parameters; and
updating the biomarker response surface based on the third set of actions and third set of biomarker outcomes associated with the third person.

10. The method of claim 9, wherein updating the biomarker response surface comprises updating based on the following rules:
weighing the first set of actions more heavily in updating the biomarker response surface, if the first set of biomarker outcomes is more similar than the second set of biomarker outcomes to the third set of biomarker outcomes; and
weighing the second set of actions more heavily in updating the biomarker response surface, if the second set of biomarker outcomes is more similar than the first set of biomarker outcomes to the third set of biomarker outcomes.

11. The method of claim 9, further comprising:
receiving a first set of well-being metric outcomes associated with the first person;
receiving a second set of well-being metric outcomes associated with the second person; and
determining, with the processor, a well-being response surface fitted to the well-being metric outcomes as a function of the first and second sets of biomarker outcomes.

12. The method of claim 11, further comprising determining, with the processor, a well-being response surface fitted to the first and second well-being metric outcomes as a function of the first and second sets of actions.

13. A system comprising:
a user interface, displayable on a computing device, configured to receive a set of characterization parameters associated with a patient and to query a database on a server that stores a plurality of biomarker response surfaces, each biomarker response surface corresponding to a patient population with a set of common characterization parameters;
a processor configured to receive an applicable biomarker response surface corresponding to a matching patient population whose set of common characterization parameters is substantially similar to the set of characterization parameters associated with the patient; and
a diagnostic engine configured to provide a treatment option for the patient based on a maximum point of the applicable biomarker response surface.

14. The system of claim 13, wherein in providing a treatment option for the patient, the diagnostic engine is configured to provide a change in an action associated with the maximum point of the applicable biomarker response surface.

15. The system of claim 14, wherein in providing a change in a characterization parameter, the diagnostic engine suggests a change in at least one of dosage and frequency of a medication.

16. The system of claim 15, wherein the processor is further configured to:
receive an applicable well-being response surface corresponding to a matching patient population whose set of biomarkers or common characterization parameters is substantially similar to a set of biomarker outcomes or characterization parameters associated with the patient; and
receive an applicable biomarker response surface that is substantially similar to the set of biomarker outcomes associated with the patient;
wherein the diagnostic engine is configured to provide a treatment option for the patient based on a maximum point of at least one of the well-being response surface and the biomarker response surface.

17. A method comprising:
receiving, on a computing device connected to a computer network, a set of characterization parameters associated with a patient;
querying a database on a server connected to the computer network and storing a plurality of biomarker response surfaces, each biomarker response surface corresponding to a patient population with a set of common characterization parameters;
receiving, on the computing device connected to the computer network, an applicable biomarker response surface corresponding to a matching patient population whose set of common characterization parameters is substantially similar to the set of characterization parameters associated with the patient;
determining a maximum point of the applicable biomarker response surface; and
providing a treatment option for the patient based on the maximum point of the applicable biomarker response surface.

18. The method of claim 17, wherein providing a treatment option for the patient includes providing a change in an action associated with the maximum point of the applicable biomarker response surface.

19. The method of claim 18, wherein providing a change in a characterization parameter includes suggesting a change in at least one of dosage and frequency of a medication.

20. The method of claim 17, further comprising:
receiving at least one of an applicable well-being response surface and an applicable biomarker response surface;
determining a maximum point of the applicable well-being response surface; and
providing a treatment option for the patient based on the maximum point of at least one of the applicable well-being response surface and the biomarker response surface.
